(19) United States
(12) Patent Application Publication
(10) Pub. No.: US 2019/0390849 A1
(43) Pub. Date: Dec. 26, 2019

(54) Connector For Aerodrome Lighting System

(71) Applicant: Kyu Bok Lee, Seoul (KR)

(72) Inventor: Kyu Bok Lee, Seoul (KR)

(21) Appl. No.: 16/444,328

(22) Filed: Jun. 18, 2019

(30) Foreign Application Priority Data
Jun. 22, 2018 (KR) 10-2018-0072211
Mar. 20, 2019 (KR) 10-2019-0031529

(51) Int. Cl. F21V 23/06; B64F 1/20; F21V 23/00; F21V 23/02

(52) U.S. Cl. CPC F21V 23/06; B64F 1/205; F21W 2111/06; F21V 23/023; F21V 23/002

(57) ABSTRACT

The present invention discloses a connector for an aerodrome lighting system for connecting a pair of primary cables and a pair of high voltage cables with each other among parts including a transformer, a pair of the primary cables connected to the transformer, a secondary cable for supplying electricity to a lamp, and a pair of the high voltage cables. The connector includes: a ⊏-shaped or U-shaped connector body; a receptacle formed integrally with an end portion of the connector body; and a plug formed integrally with the other end portion of the connector body, wherein the receptacle and the plug are formed integrally inside the connector and are electrically connected with each other. Two connectors are used in one aerodrome lighting system. One of the connectors connects the plug of the primary cable to the receptacle and connects the plug to the receptacle of the outgoing high voltage cable. The other connector connects the plug of the incoming high voltage cable to the receptacle and connects the plug to the receptacle of the incoming primary cable.

### FIELD OF THE INVENTION

The present invention relates to a connector for cables. More specifically, the present invention is directed to a connector for connecting pair of cables accommodated in confined housing so that the connected pair of cables are not bent or curved at their connection. The present connector is suitable for aerodrome lighting systems which are buried in a landing strip or an access road of an airport at regular intervals to connects cables accommodated in a can box of the aerodrome lighting system.

### BACKGROUND OF THE INVENTION

Different types of lighting facilities or illumination facilities are used to ensure safe navigation, landing and takeoff of aircraft. Usually such lighting facilities are installed on ground, airport, aviation obstacle structures or on the aircraft and includes airport lighting facilities, air route lighting facilities, aviation obstacle lighting facilities, and aircraft lighting facilities. Broadly such lighting facilities are called aerodrome lighting facilities. The air route lighting facilities among the aerodrome lighting facilities can be categorized in two types such as an exposed type aerodrome lighting system which is normally installed on landing strip or access road of the airport and an embedded type aerodrome lighting system which is normally buried in the landing strip or the access road.

The accompanying FIG. 1 is a schematic representation of such embedded type aerodrome lighting system embodiment 100. Multiple of these aerodrome lighting systems are buried in the landing strip or the access road of the airport at regular intervals. These aerodrome lighting systems are used to emit light and display entire stretch of the landing strip or the access road so that the aircrafts can safely take off, land and navigate from/on the landing strip or the access road.

Typically the embedded type aerodrome lighting system 100 as illustrated in the FIG. 1 includes a cylindrical main body 10, namely, the can box, made of steel, and a cover 20 assembled to an upper portion of the main body 10. A lower body (not shown) of the main body 10 is buried deeper into the ground. The main body 10 is buried under the landing strip or the access road in such a manner that, the cover 20 assembled on the main body 10 is stayed at same height as surface of the landing strip or the access road.

The cover 20 usually includes two lamps 21 for emitting the light, so that a pilot unsticks, lands or moves an aircraft in safety following the light of the lamps 21.

The lighting system 100 also includes plurality of cables for connecting its various components including transformer. These cables and the components are complicatedly mounted below the cover 20, and inside the main body 10. The accompanying FIG. 2 schematically illustrates the components and the cables which are mounted inside the main body 10 under the cover 20.

As shown in the FIG. 2, the components mounted inside the main body 10 preferably includes a transformer 30, a pair of primary cables 32a and 32b connected to the transformer 30, a secondary cable 33 for supplying electricity to the lamp 21, and a pair of high voltage cables 31a and 31b respectively connected to the primary cables 32a and 32b.

A receptacle 34 is integrally disposed at an end portion of the secondary cable 33, and a plug 23 is disposed at an end portion of a power cable 22 connected to the cover 20, so that the receptacle 34 and the plug 23 are combined with each other. A receptacle 32c is integrally disposed at an end portion of the incoming primary cable 32a, and a plug 31c is disposed at an end portion of the incoming high voltage cable 31a, so that the receptacle 32c and the plug 31c are combined with each other. Similarly, a plug 32d is integrally disposed at an end portion of the outgoing primary cable 32b, and a receptacle 31d is disposed at an end portion of the outgoing high voltage cable 31b, so that the receptacle 31d and the plug 32d are combined with each other.

In the above cable connection configuration, contact failure usually occurs at a portion where the primary cables 32a and 32b and the high voltage cables 31a and 31b are connected. As these cables and the connectors are accommodated inside the can box 10, the cables are bent or curved in their contact due to confined inner space of the can box 10. Such curved or bended disposition of the cables causes loose contact between contact making receptacle and plug which often results contact failure. That is, the receptacle 32c and the plug 31c for connecting the incoming primary cable 32a and the incoming high voltage cable 31a with each other get disconnected, or the receptacle 31d and the plug 32d for connecting the outgoing primary cable 32b and the outgoing high voltage cable 31b with each other get disconnected. If such contact failure occurs, the lamps 21 of the aerodrome lighting systems 100 installed in the landing strip are turned off, and it causes difficulty in taking off, landing and moving an aircraft in safety. Therefore, it is required to maintain a stable contact between an incoming contact point and an outgoing contact point for connecting the transformer 30 and the high voltage cable 31 with each other and to prevent contact failure between the plug and the receptacle of a contact kit forming the contact points.

As described above, because lots of cables are complicatedly tangled and accommodated within the narrow inner space of the can box 10, a device for arranging the cables has been developed. Korean Patent Application Publication No. 10-2015-0049416 discloses a cable holder attached to the inside of a can box to hold complicated cables in the can box. However, even though the cables are held on the holder to be arranged, the problem of the contact failure occurring at the portions where the primary cables of the transformer of the embedded aerodrome lighting system and the high voltage cables are connected, cannot be solved.

Korean Utility Model Registration No. 20-0325812 discloses an aerodrome lighting system having earth terminals to cope with an electrical short occurring at the aerodrome lighting system.

Korean Patent No. 10-1855387 discloses an aerodrome lighting system having a stepped portion that a cylindrical diameter of a lower can box is larger than a cylindrical diameter of an upper can box in order to solve the problem that a landing strip or an access road is destroyed or has cracks due to the aerodrome lighting system. However, also the aerodrome lighting system disclosed in Korean Utility Model Registration No. 20-0325812 cannot solve the problem of the contact failure occurring at the portions where the primary cables of the transformer of the embedded aerodrome lighting system and the high voltage cables are connected.

It is thus there has been a need for developing a connector system for aerodrome lighting system in order to solve the problem of disconnection or contact failure occurring at the portions where the primary cables of the transformer of the aerodrome lighting system mounted inside the can box and the high voltage cables are connected.

### SUMMARY OF THE INVENTION

Accordingly, the present invention has been made to solve the above-mentioned problems occurring in the prior arts, and it is an object of the present invention to provide a connector for an aerodrome lighting system, which can solve the problem of disconnection or contact failure occurring at portions where primary cables and high voltage cables of a transformer of the aerodrome lighting system mounted inside a can box of the aerodrome lighting system are connected.

Another object of the present invention is to provide a connector for an aerodrome lighting system, which can prevent the primary cables and the high voltage cables of the transformer mounted inside the can box of the aerodrome lighting system from being bent or curved, thereby solving the problem of disconnection or contact failure occurring at the portions where the cables are connected.

A further object of the present invention is to provide a connector for an embedded type aerodrome lighting system, which can solve the problem of disconnection or contact failure occurring in the can box of the embedded type aerodrome lighting system, thereby preventing inconvenience or accidents due to lights-out of lamps when an aircraft takes off, lands or moves.

Aforementioned objects and other objects of the present invention can be all achieved by the present invention described in detail as follows.

To accomplish the aforementioned object, according to the present invention, a connector for an aerodrome lighting system is provided for connecting a pair of primary cables and a pair of high voltage cables with each other among parts including a transformer, a pair of the primary cables connected to the transformer, a secondary cable for supplying electricity to a lamp, and a pair of the high voltage cables, the connector including: an open square/rectangle (⊏)-shaped or U-shaped connector body having a connector base and contiguously extending pair of connector arms at ends of said connector base; a receptacle formed integrally with end portion of one of the connector arms; and a plug formed integrally with end portion of other one of the connector arms, wherein the receptacle and the plug are formed integrally inside the connector arms and are electrically connected with each other through the connector body.

Moreover, two connectors are used in one aerodrome lighting system, and one of the connectors connects the plug of the primary cable to the receptacle and connects the plug to the receptacle of the outgoing high voltage cable, and the other connector connects the plug of the incoming high voltage cable to the receptacle and connects the plug to the receptacle of the incoming primary cable.

Furthermore, the receptacle and the plug are formed integrally inside the open square/rectangle (⊏) shaped or U-shaped body to be electrically connected with each other. The main body must be manufactured of rubber or synthetic resin which can endure high voltage of 7,000 volts or more. Preferably, the main body is made of thermoplastic elastomer. The receptacle and the plug are made of conductive metal, and preferably, copper.

Hereinafter, an embodiment of the present invention will be described in detail with reference to the accompanying drawings.

### BRIEF DESCRIPTION OF THE DRAWINGS

The aforementioned and other objects, features and advantages of the present invention will be apparent from the following detailed description of the preferred embodiments of the invention in conjunction with the accompanying drawings, in which:

FIG. 1 is a perspective view of a conventional aerodrome lighting system buried in a landing strip or an access road of an airport to emit light so that an aircraft can take off, land or move in safety;

FIG. 2 is perspective view showing parts mounted inside a main body including a cover of the conventional aerodrome lighting system of FIG. 1;

FIG. 3 is a perspective view showing a state where a pair of primary cables are separated from a pair of high voltage cables of FIG. 2;

FIG. 4 is a perspective view of a connector for an aerodrome lighting system;

FIG. 5 is a sectional view of the connector of FIG. 4;

FIG. 6 is a mimic diagram showing a state where parts mounted inside the main body of the aerodrome lighting system are connected; and

FIG. 7 is a perspective view showing a state where the connector connects cables inside the main body of the aerodrome lighting system and is mounted perpendicularly.

### DETAILED DESCRIPTION OF THE INVENTION

The present invention relates to a connector for aerodrome lighting systems which are buried in the landing strip or the access road at regular intervals. More specifically, the present invention relates to a connector for an embedded aerodrome lighting system, which connects cables in a can box of the aerodrome lighting system.

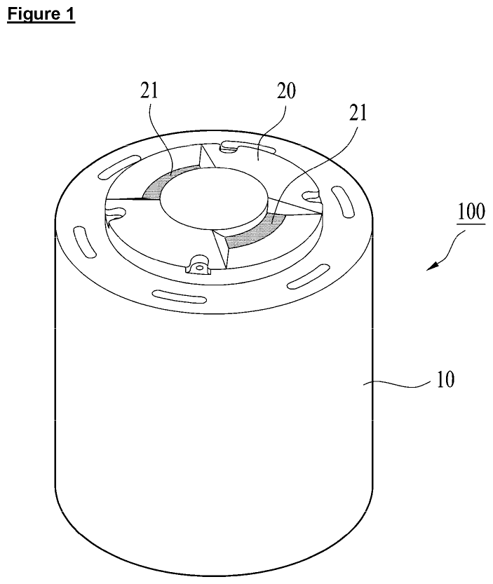

Aerodrome lighting systems are buried in the landing strip or the access road of the airport at regular intervals in order to emit light and illuminate entire stretch of the landing strip or the access road, so that aircrafts can take off, land and move in safety. FIG. 1 is a perspective view of the conventional aerodrome lighting system.

As shown in FIG. 1, the embedded type aerodrome lighting system 100 includes a cylindrical main body 10, namely, a can box, made of steel, and a cover 20 assembled to an upper portion of the main body 10. A lower body (not shown) of the main body 10 is buried deeper into the ground. The main body 10 is buried under the landing strip or the access road in such a manner that the cover 20 assembled on the main body 10 is stayed at the same height as the surface of the landing strip or the access road.

The cover 20 includes two lamps 21 for emitting light, so that a pilot unsticks, lands or moves an aircraft in safety following the light of the lamps 21. A plurality of cables for connecting various parts including a transformer is complicatedly mounted below the cover 20, namely, inside the main body 10.

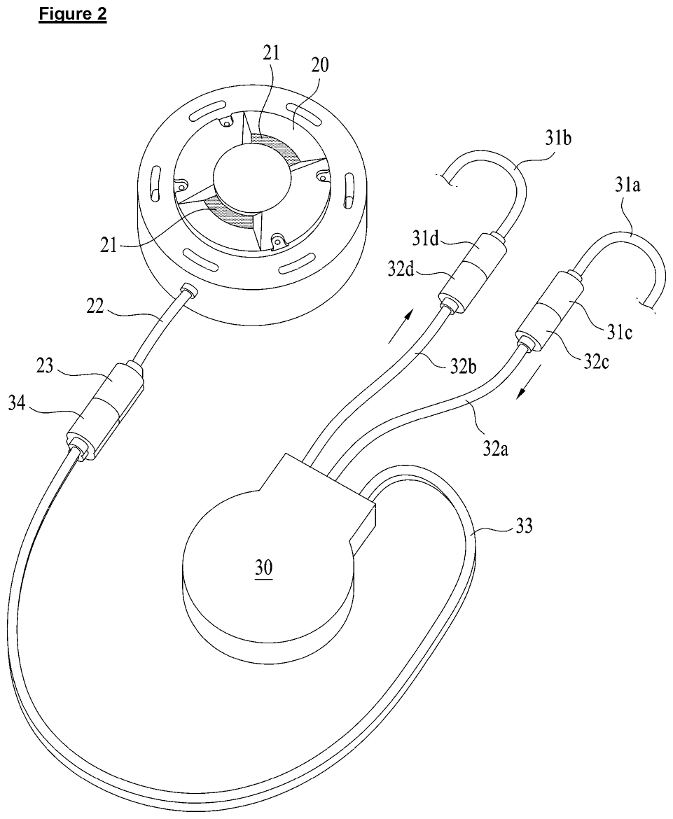

FIG. 2 schematically illustrates the various components mounted inside the main body 10 including the cover 20.

As shown in FIG. 2, the components mounted inside the main body 10 are a transformer 30, a pair of primary cables 32a and 32b connected to the transformer 30, a secondary cable 33 for supplying electricity to a lamp 21, and a pair of high voltage cables 31a and 31b respectively connected to the primary cables 32a and 32b.

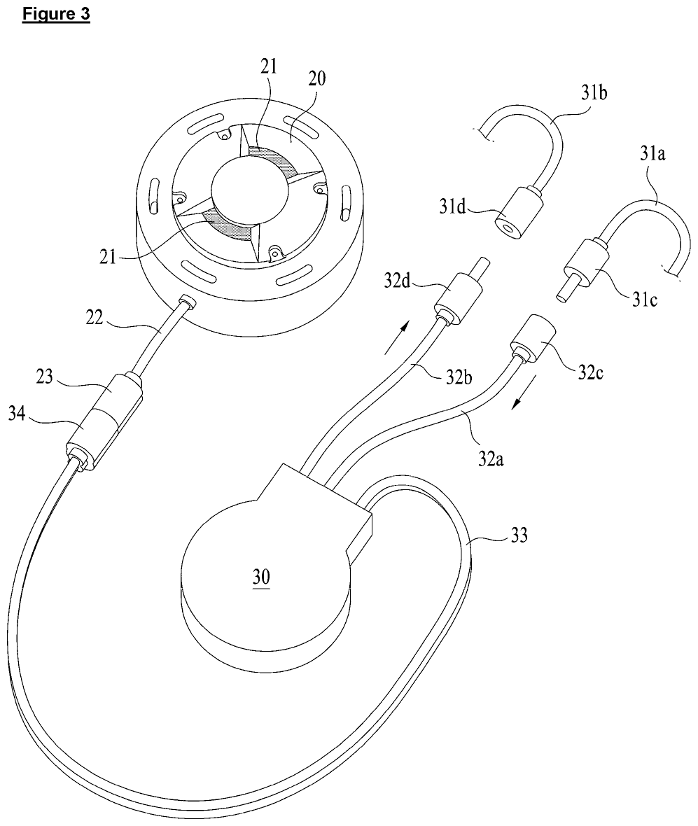

FIG. 3 is a perspective view showing a state where a pair of the primary cables 32a and 32b is separated from a pair of the high voltage cables 31a and 31b.

A receptacle 34 is integrally disposed at an end portion of the secondary cable 33, and a plug 23 is disposed at an end portion of a power cable 22 connected to the cover 20, so that the receptacle 34 and the plug 23 are combined with each other. A receptacle 32c is integrally disposed at an end portion of the incoming primary cable 32a, and a plug 31c is disposed at an end portion of the incoming high voltage cable 31a, so that the receptacle 32c and the plug 31c are combined with each other. A plug 32d is integrally disposed at an end portion of the outgoing primary cable 32b, and a receptacle 31d is disposed at an end portion of the outgoing high voltage cable 31b, so that the receptacle 31d and the plug 32d are combined with each other.

However, contact failure may occur at a portion where the primary cables 32a and 32b and the high voltage cables 31a and 31b are connected. That is, the receptacle 32c and the plug 31c for connecting the incoming primary cable 32a and the incoming high voltage cable 31a with each other are not making contact, or the receptacle 31d and the plug 32d for connecting the outgoing primary cable 32b and the outgoing high voltage cable 31b with each other are not making contact. If such contact failure occurs, the lamps 21 of the aerodrome lighting systems 100 installed in the landing strip are turned off, and it causes difficulty in taking off, landing and moving an aircraft in safety. Therefore, it is required to maintain a stable contact between an incoming contact point and an outgoing contact point for connecting the transformer 30 and the high voltage cable 31 with each other and to prevent contact failure between the plug and the receptacle of a contact kit forming the contact points.

However, when the can box 10 of the aerodrome lighting system 100 is installed, because a space of the can box 10 is narrow, the cables are bent or curved in the contact kit, and it causes contact failure due to loose contact between the contact makers of the receptacle and the plug.

Therefore, the present invention provides a new connector to connect pair of cables free of any bent or curve even when placed in enclosed housing. The connector is particularly suitable for using in the aerodrome lighting system and solve the problem of disconnection or contact failure occurring at portions where primary cables and high voltage cables of the transformer mounted inside the can box of the aerodrome lighting system are connected.

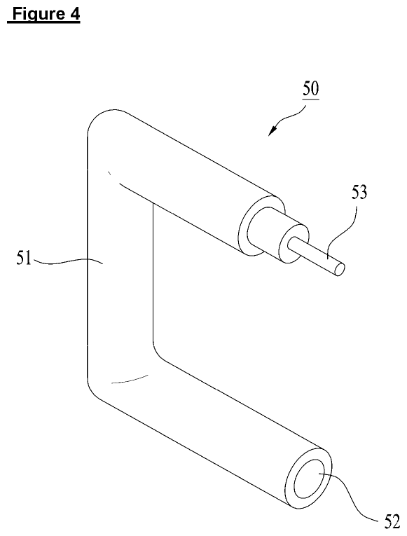

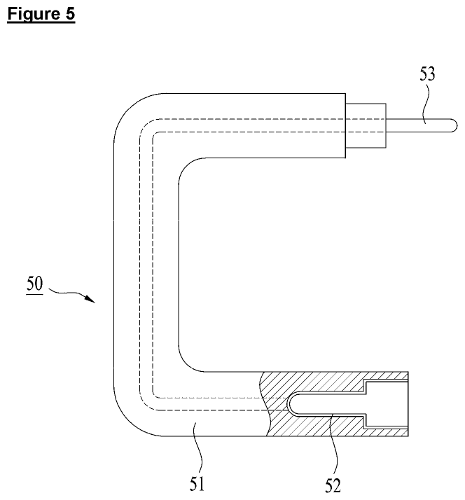

FIG. 4 is a perspective view of the present connector 50 connecting the pair of cables free of any curved or bend disposition at their connection while accommodated in a confined enclosure. FIG. 5 is a sectional view of the connector 50 of FIG. 4.

Among components of the aerodrome lighting system including a transformer 30, a pair of primary cables 32a and 32b connected to the transformer 30, a secondary cable 33 for supplying electricity to a lamp 21, and a pair of high voltage cables (incoming and outgoing) 31a and 31b, the connector 50 is a connector for connecting a pair of the primary cables 32a and 32b and a pair of the high voltage cables (incoming and outgoing) 31a and 31b with each other. The connector 50 basically includes an open square/rectangular (⊏)-shaped or U-shaped connector body 51 defined by a connector base and contiguously extending pair of connector arms at ends of the connector base, a receptacle 52 formed integrally with end portion of one of the connector arms, and a plug 53 formed integrally with end portion of the other connector arm. The receptacle 52 and the plug 53 are electrically connected with each other within the connector body 51. In a preferred embodiment, the receptacle or the plug of the connector arms are configured to connect with corresponding plug or receptacle of one of the connecting pair of cables.

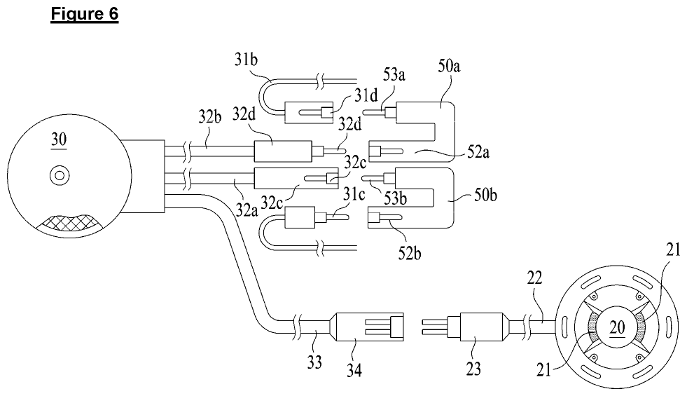

FIG. 6 is a mimic diagram showing a state where the parts mounted inside the main body 10 of the aerodrome lighting system 100 are connected.

As shown in the FIG. 6, the aerodrome lighting system 100 preferably includes two connectors 50a and 50b. The connector 50a is connected with the plug 32d of the primary cable 32b at its receptacle 52a end and further connected with the receptacle 31d of the outgoing high voltage cable 31b at its plug 53a end. The other connector 50b is connected with the plug 31c of the incoming high voltage cable 31a at its receptacle 52b end, and further connected with the receptacle 32c of the incoming primary cable 32a at its plug 53b end.

The receptacle 52 and the plug 53 are formed integrally inside the connector arms of the connector body 51 to be electrically connected with each other. The connector body 51 is manufactured from rubber or synthetic resin which can endure high voltage of 7,000 volts or more. Preferably, the connector body is made from thermoplastic elastomer. The connector 50 is 5,000 volts in rated voltage and 10.0 A in rated current. The receptacle 52 and the plug 53 may be made of conductive metal, and preferably, made of copper.

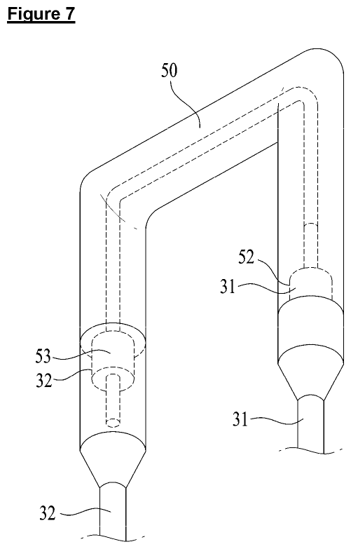

Currently installed aerodrome lighting systems 100 are buried in an inner space of the can box 10 in a state where a plurality of cables are bent or curved, but, as times goes by, the connected plug and receptacle loosen, and it causes contact failure. When the connector 50 according to the present invention is used, the extending pair of the connector arms at the connector base ends, which are disposed substantially perpendicular to the connector base, connected to the pair of cables can keep the connecting pair of cables parallel to each other and accordingly the connected pair of cables are not bent or curved even when housed inside the can box of the aerodrome lighting system. FIG. 7 is a perspective view showing a state where the connector connects the cables inside the main body of the aerodrome lighting system and is mounted perpendicularly. Because the cables connected to the connector 50 are not bent or curved, the present invention can prevent disconnection or contact failure caused by release of the bent or curved cables.

As described above, while the present invention has been particularly shown and described with reference to the example embodiments thereof, it will be understood by those of ordinary skill in the art that the present invention is not limited to the structure and actions described in the specification and various changes, modifications and equivalents may be made in the present invention without departing from the technical scope and idea of the present invention. Therefore, it would be understood that all of the changes, modifications and equivalents belong to the scope of the present invention.

What is claimed is:

1. A connector system for connecting pair of cables free of any bent or curve affecting electrical connectivity even when placed in enclosed housing comprising:
at least one ⊏-shaped or U-shaped rigid connector body defining a connector base and contiguously extending pair of connector arms at ends of said connector base;
one of said connector arms having a receptacle formed integrally at an end portion thereof; and
other of said connecting arms having a plug formed integrally at an end portion thereof;
said receptacle and said plug being electrically connected with each other within said connector body.

2. The connector system as claimed in claim 1 comprising a connector in an aerodrome lighting system for connecting a pair of primary cables and a pair of high voltage cables with each other comprising a transformer, the pair of primary cables connected to the transformer, a secondary cable for supplying electricity to a lamp, and the pair of high voltage cables.

3. The connector system as claimed in claim 2 for the aerodrome lighting system further comprising a second ⊏-shaped or U-shaped rigid connector body in one of the aerodrome lighting system;
whereby one of the ⊏-shaped or U-shaped rigid connector body is adapted to connect with a plug of the outgoing primary cable at its receptacle end and with a receptacle of the outgoing high voltage cable at its plug end,
and the other of the ⊏-shaped or U-shaped rigid connector body is adapted to connect with a plug of the incoming high voltage cable at its receptacle end and with a receptacle of the incoming primary cable at its plug end.

4. The connector system as claimed in claim 1 wherein the ⊏-shaped or U-shaped rigid connector body is comprised of rubber or synthetic resin which can endure high voltage of 7,000 volts or more, and the receptacle and the plug portions are made of conductive metal.

5. The connector system as claimed in claim 4, wherein the rubber is thermoplastic elastomer.

6. The connector system as claimed in claim 1 being adapted for connecting pair of the cables and housing inside a can box of the aerodrome lighting systems free of bent and/or curve.

7. The connector system as claimed in claim 1, wherein the extending pair of the connector arms at the connector base ends are disposed substantially perpendicular to the connector base and wherein connecting ends of the cables are securely connecting in line with said respective connecting arm through said receptacle or said plug and secured to said rigid connector body without any bending or curve even when housed inside a can box such as of an aerodrome lighting system.
